(19) United States
(12) Patent Application Publication
(10) Pub. No.: US 2018/0311799 A1
(43) Pub. Date: Nov. 1, 2018

(54) SCREWDRIVER BIT WITH RESIDUAL STRESS-RELIEF GROOVES

(71) Applicant: Shao-Hsien Hsu, Taichung City (TW)

(72) Inventor: Shao-Hsien Hsu, Taichung City (TW)

(21) Appl. No.: 15/497,216

(22) Filed: Apr. 26, 2017

(51) Int. Cl. B25B 15/00

(52) U.S. Cl. CPC B25B 15/005; B25B 23/0035

(57) ABSTRACT

A screwdriver bit includes a shank and a function portion which is integrally formed with the shank. The function portion includes a driving end and a transitional portion which is integrally formed with the driving end. At least one residual stress-relief groove is defined in the outer surface of the transitional portion. The at least one residual stress-relief groove includes a start point and an end point. The start point is located at the lowest point of one of chip flutes of the screwdriver bit. The end point is located at a conjunction portion between the transitional portion and the shank. The least one residual stress-relief groove adjusts the locations of the residual stress-relief groove of surface extension of the screwdriver bit, or even removes the residual stress-relief groove of surface extension of the transitional portion.

### BACKGROUND OF THE INVENTION

### 1. Fields of the Invention

The present invention relates to a screwdriver bit, and more particularly, to a screwdriver bit with residual stress-relief grooves.

### 2. Descriptions of Related Art

The conventional screwdriver bit is disclosed in FIG. 1 and comprises a shank 1 and a function portion 2 which is integrally formed with the shank 1. The shank 1 is connected with a tool which rotates the screwdriver bit to use the driving end 21 of the function portion 2 to tighten or loosen an object such as a bolt. The function portion 2 includes recessed and curved transitional portion 22. When the screwdriver bit is applied by a torque, the transitional portion 22 is deformed. As shown in FIG. 2, along with the increase of the torque, the deformation increases. Before the torque applied to the driving end 21 reaches the yield point “P”, the deformation is in the elastic area, and this can be restored. When the torque applied to the driving end 21 goes beyond the yield point “P”, the deformation is in the plastic area, and this cannot be restored. However, the deformation curve is still developed after passing the yield point. In other words, even the torque does not increase, the deformation due to the torque continues. The users have to stop using the screwdriver bit when the deformation to the transition portion 22 is acknowledged to prevent the driving end 21 from breaking.

The transitional portion 22 of the screwdriver bit receives significant heat and torque during being manufactured, this causes residual stress remained in the screwdriver bit. The residual stress affects stability, statistic strength, and fatigue strength. When the screwdriver bit is applied by a torque, the residual stress may break or damage the transitional portion 22. Therefore, the relief for the residual stress is needed. There are three conventional ways to release the residual stress, the first way is to leave the screwdriver bit for a period of time, and the residual stress will be removed. The second way is to heat the screwdriver bit to gradually remove the residual stress. However, pollution and consumption of energy are concerned. The third way is to vibrate the screwdriver bit to remove the residual stress by way of mechanical resonance.

The present invention intends to provide a screwdriver bit with residual stress-relief grooves so as to improve the shortcomings mentioned above.

### SUMMARY OF THE INVENTION

The present invention relates to a screwdriver bit and comprises a shank and a function portion which is integrally formed with the shank. The function portion includes a driving end and a transitional portion which is integrally formed with the driving end. The transitional portion is a recessed and curved cylindrical portion. At least one residual stress-relief groove is defined in the outer surface of the transitional portion.

Preferably, the at least one residual stress-relief groove extends along the axial direction of the transitional portion.

Preferably, the at least one residual stress-relief groove includes a start point and an end point. The start point is located at the lowest point of one of chip flutes of the screwdriver bit. The end point is located at the conjunction portion between the transitional portion and the shank.

Preferably, there are two residual stress-relief grooves which are located 180 degrees away from each other.

Preferably, the at least one residual stress-relief groove spirally extends along with the spiral direction of the transitional portion.

Preferably, the at least one residual stress-relief groove includes a start point and an end point. The start point is located at the lowest point of one of chip flutes of the screwdriver bit, and the end point is located at the conjunction portion between the transitional portion and the shank.

Preferably, there are two residual stress-relief grooves which extend in the same direction and are located 180 degrees away from each other.

Preferably, there are two residual stress-relief grooves which extend in opposite directions and are located 180 degrees away from each other.

Preferably, there are two residual stress-relief grooves which extend in opposite directions and intersect each other.

Preferably, there are two groups of the residual stress-relief grooves and each group includes two residual stress-relief grooves which extend in opposite directions and intersect each other. The two groups of the residual stress-relief grooves are located 180 degrees away from each other.

The at least one residual stress-relief groove makes the surface of the transitional portion of the screwdriver bit be a non-continuous surface so that the residual stress cannot extend and continue along the surface. The at least one residual stress-relief groove reduces the residual stress of surface extension or even eliminates the residual stress of surface extension in the transitional portion.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional screwdriver bit;

FIG. 2 discloses the curve of the torque-deformation of the conventional screwdriver bit;

FIG. 3 is a perspective view to show the first embodiment of the screwdriver bit of the present invention;

FIG. 4 shows the plane view of the first embodiment of the screwdriver bit of the present invention;

FIG. 5 is a cross sectional view, taken along line V-V in FIG. 4;

FIG. 6 is a perspective view to show the second embodiment of the screwdriver bit of the present invention;

FIG. 7 shows the plane view of the second embodiment of the screwdriver bit of the present invention;

FIG. 8 is a cross sectional view, taken along line VIII-VIII in FIG. 7;

FIG. 9 is a perspective view to show the third embodiment of the screwdriver bit of the present invention;

FIG. 10 shows the plane view of the third embodiment of the screwdriver bit of the present invention, and

FIG. 11 is a cross sectional view, taken along line XI-XI in FIG. 10.

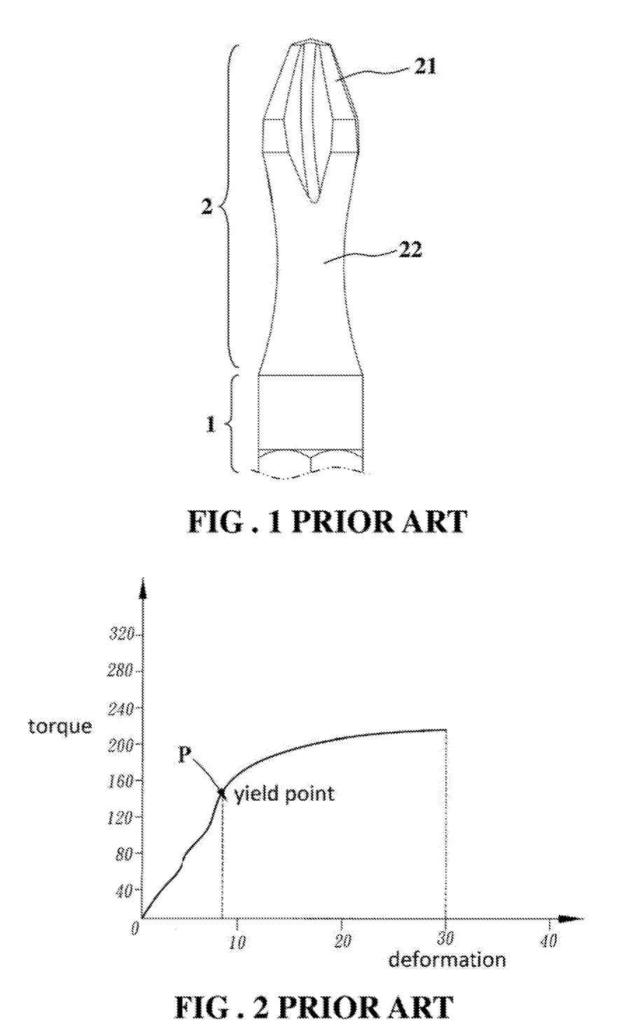

### DETAILED DESCRIPTION OF THE PREFERRED EMBODIMENT

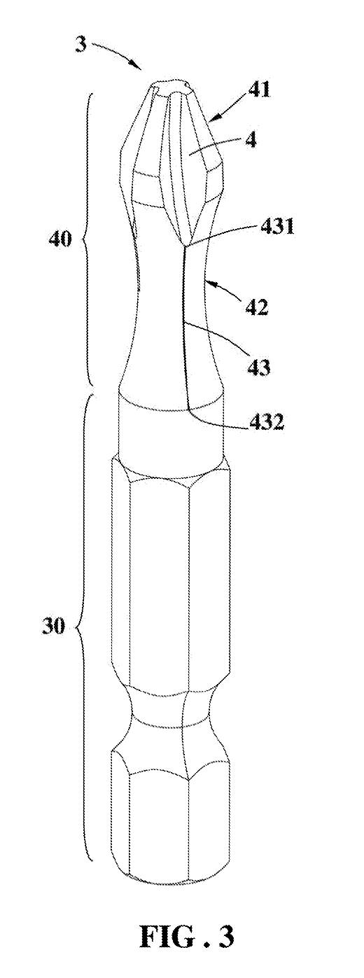

Referring to FIGS. 3, 6 and 9, the screwdriver bit 3 of the present invention comprises a shank 30 and a function portion 40 which is integrally formed with the shank 30. The function portion 40 includes a driving end 41 and a transitional portion 42 which is integrally formed with the driving end 41. The transitional portion 42 is a recessed and curved cylindrical portion. At least one residual stress-relief groove 43 or at least one group of the residual stress-relief grooves 43, 45, 47 is defined in the outer surface of the transitional portion 42.

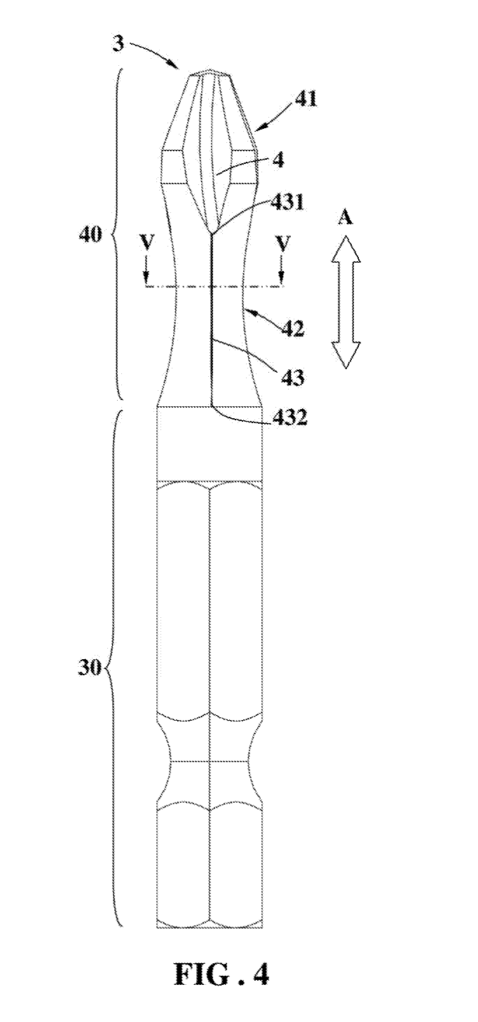

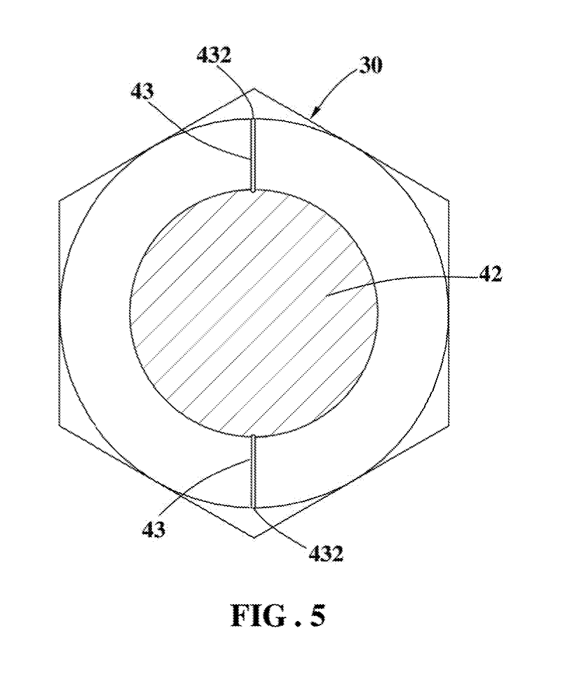

As shown in FIGS. 3 to 5, the at least one residual stress-relief groove 43 extends along the axial direction as shown by the arrowhead “A” of the transitional portion 42. The at least one residual stress-relief groove 43 includes a start point 431 and an end point 432. The start point 431 is located at the lowest point of one of chip flutes of the screwdriver bit 3, and the end point 432 is located at the conjunction portion between the transitional portion 42 and the shank 30. There are two residual stress-relief grooves 43 which are located 180 degrees away from each other.

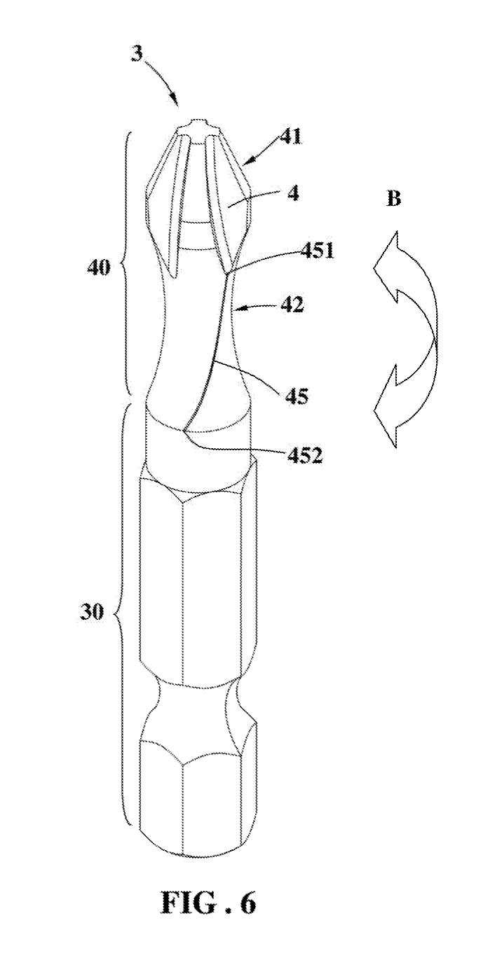

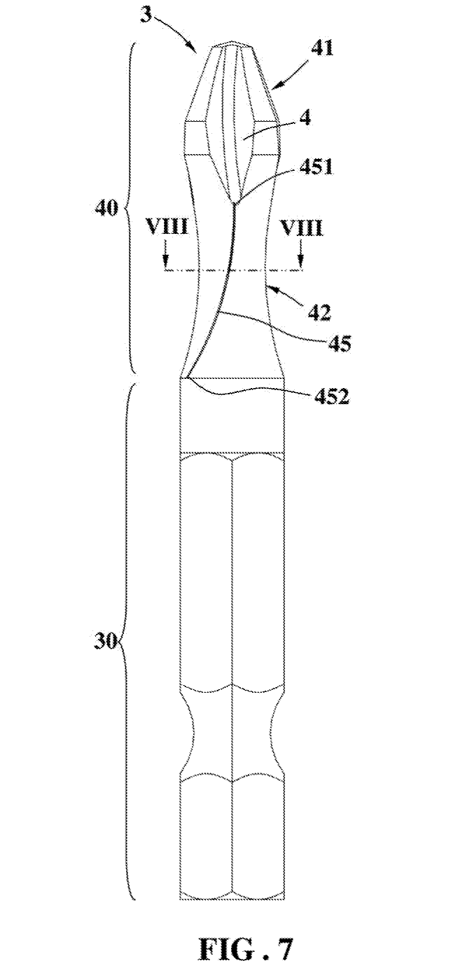

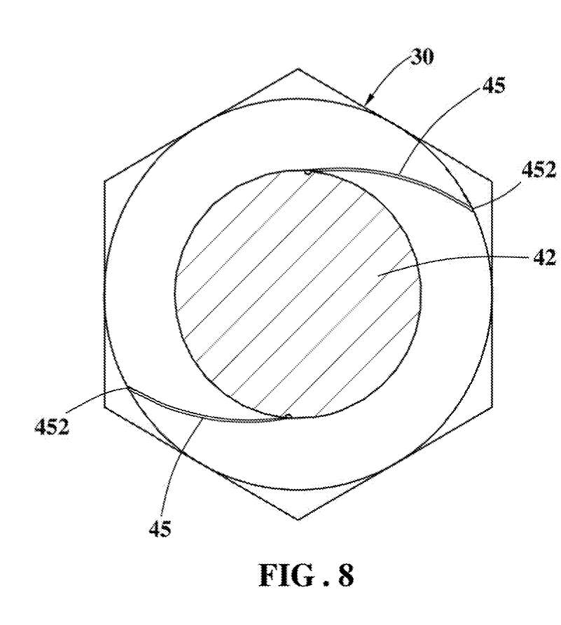

As shown in FIGS. 6 to 8, the at least one residual stress-relief groove 45 spirally extends along with the spiral direction as shown by the arrowhead “B” of the transitional portion 42. The at least one residual stress-relief groove 45 includes a start point 451 and an end point 452. The start point 451 is located at the lowest point of one of chip flutes 4 of the screwdriver bit 3. The end point 435 is located at a conjunction portion between the transitional portion 42 and the shank 30. There are two residual stress-relief grooves 45 which extend in the same direction and are located 180 degrees away from each other.

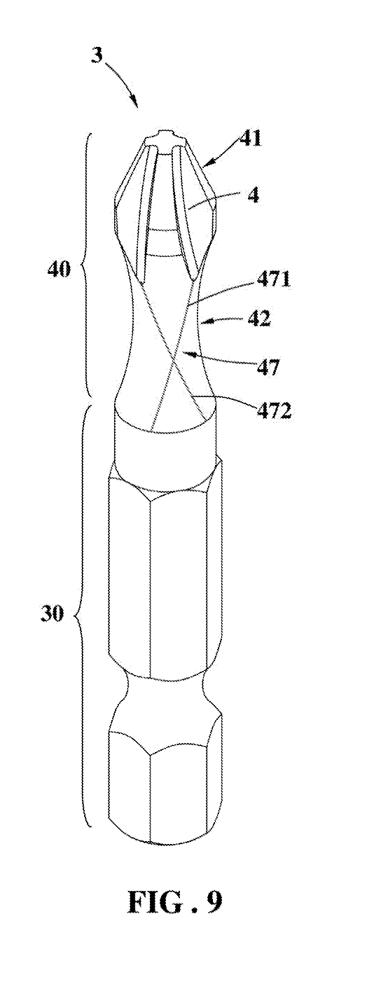

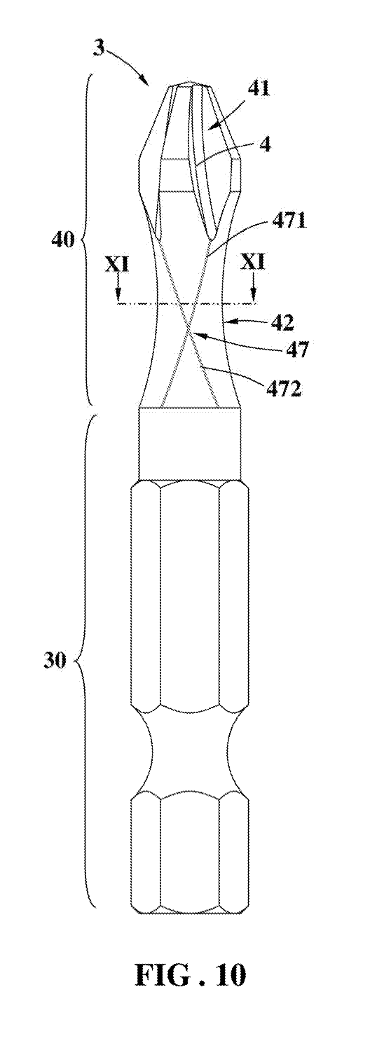

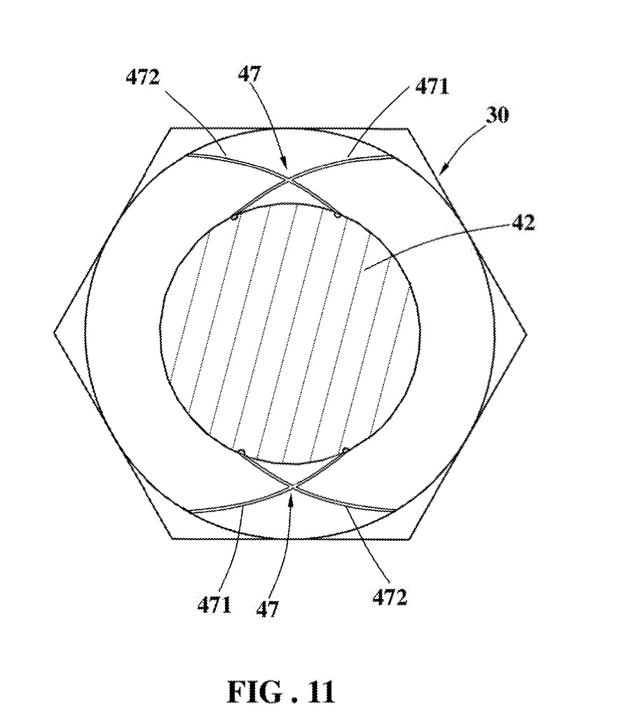

As shown in FIGS. 9 to 11, there are two groups of the residual stress-relief grooves 47 and each group includes a first residual stress-relief groove 471 and a second residual stress-relief groove 472. The first and second residual stress-relief grooves 471, 472 extend in opposite directions and intersect each other. The first and second residual stress-relief grooves 471, 472 spirally extend along the spiral direction as shown by the arrowhead “B” of the transitional portion 42.

The residual stress-relief grooves 43, 45, 47 make the surface of the transitional portion 42 of the screwdriver bit 3 be a non-continuous surface. The residual stress cannot extend and continue along the surface. The residual stress-relief grooves 43, 45, 47 reduce the residual stress of surface extension or even eliminates the residual stress of surface extension in the transitional portion 42.

While we have shown and described the embodiment in accordance with the present invention, it should be clear to those skilled in the art that further embodiments may be made without departing from the scope of the present invention.

What is claimed is:

1. A screwdriver bit comprising:
a shank and a function portion which is integrally formed with the shank, the function portion including a driving end and a transitional portion which is integrally formed with the driving end, the transitional portion is a recessed and curved cylindrical portion, and
at least one residual stress-relief groove defined in an outer surface of the transitional portion.

2. The screwdriver bit as claimed in claim 1, wherein the at least one residual stress-relief groove extends along an axial direction of the transitional portion.

3. The screwdriver bit as claimed in claim 2, wherein the at least one residual stress-relief groove includes a start point and an end point, the start point is located at a lowest point of one of chip flutes of the screwdriver bit, the end point is located at a conjunction portion between the transitional portion and the shank.

4. The screwdriver bit as claimed in claim 3, wherein there are two residual stress-relief grooves which are located 180 degrees away from each other.

5. The screwdriver bit as claimed in claim 1, wherein the at least one residual stress-relief groove spirally extends along with the spiral direction of the transitional portion.

6. The screwdriver bit as claimed in claim 5, wherein the at least one residual stress-relief groove includes a start point and an end point, the start point is located at a lowest point of one of chip flutes of the screwdriver bit, the end point is located at a conjunction portion between the transitional portion and the shank.

7. The screwdriver bit as claimed in claim 6, wherein there are two residual stress-relief grooves which extend in the same direction and are located 180 degrees away from each other.

8. The screwdriver bit as claimed in claim 6, wherein there are two residual stress-relief grooves which extend in opposite directions and are located 180 degrees away from each other.

9. The screwdriver bit as claimed in claim 6, wherein there are two residual stress-relief grooves which extend in opposite directions and intersect each other.

10. The screwdriver bit as claimed in claim 6, wherein there are two groups of the residual stress-relief grooves and each group includes two residual stress-relief grooves which extend in opposite directions and intersect each other, the two groups of the residual stress-relief grooves are located 180 degrees away from each other.
